(19) United States
(12) Patent Application Publication
(10) Pub. No.: US 2006/0229852 A1
(43) Pub. Date: Oct. 12, 2006

(54) Zeta statistic process method and system

(75) Inventors: Anthony J. Grichnik, Peoria, IL (US); Michael Seskin, Cardiff, CA (US); Vijaya Bhasin, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/101,554

(22) Filed: Apr. 8, 2005

(51) Int. Cl. G06F 17/10

(52) U.S. Cl. 703/2

(57) ABSTRACT

A computer-implemented method is provided for model optimization. The method may include obtaining respective distribution descriptions of a plurality of input parameters to a model and specifying respective search ranges for the plurality of input parameters. The method may also include simulating the model to determine a desired set of input parameters based on a zeta statistic of the model and determining respective desired distributions of the input parameters based on the desired set of input parameters.

### TECHNICAL FIELD

This disclosure relates generally to computer based mathematical modeling techniques and, more particularly, to methods and systems for identifying desired distribution characteristics of input parameters of mathematical models.

### BACKGROUND

Mathematical models, particularly process models, are often built to capture complex interrelationships between input parameters and outputs. Neural networks may be used in such models to establish correlations between input parameters and outputs. Because input parameters may be statistically distributed, these models may also need to be optimized, for example, to find appropriate input values to produce a desired output. Simulation may often be used to provide such optimization.

When used in optimization processes, conventional simulation techniques, such as Monte Carlo or Latin Hypercube simulations, may produce an expected output distribution from knowledge of the input distributions, distribution characteristics, and representative models. G. Galperin et al., “Parallel Monte-Carlo Simulation of Neural Network Controllers,” available at http://www-fp.mcs.anl.gov/ccst/research/reports_pre1998/neural_network/galperin.html, describes a reinforcement learning approach to optimize neural network based models. However, such conventional techniques may be unable to guide the optimization process using interrelationships among input parameters and between input parameters and the outputs. Further, these conventional techniques may be unable to identify opportunities to increase input variation that has little or no impact on output variations.

Methods and systems consistent with certain features of the disclosed systems are directed to solving one or more of the problems set forth above.

### SUMMARY OF THE INVENTION

One aspect of the present disclosure includes a computer-implemented method for model optimization. The method may include obtaining respective distribution descriptions of a plurality of input parameters to a model and specifying respective search ranges for the plurality of input parameters. The method may also include simulating the model to determine a desired set of input parameters based on a zeta statistic of the model and determining respective desired distributions of the input parameters based on the desired set of input parameters.

Another aspect of the present disclosure includes a computer system. The computer system may include a console and at least one input device. The computer system may also include a central processing unit (CPU). The CPU may be configured to obtain respective distribution descriptions of a plurality of input parameters to a model and specify respective search ranges for the plurality of input parameters. The CPU may be further configured to simulate the model to determine a desired set of input parameters based on a zeta statistic of the model and determine respective desired distributions of the input parameters based on the desired set of input parameters.

Another aspect of the present disclosure includes a computer-readable medium for use on a computer system configured to perform a model optimization procedure. The computer-readable medium may include computer-executable instructions for performing a method. The method may include obtaining distribution descriptions of a plurality of input parameters to a model and specifying respective search ranges for the plurality of input parameters. The method may also include simulating the model to determine a desired set of input parameters based on a zeta statistic of the model and determining desired distributions of the input parameters based on the desired set of input parameters.

### BRIEF DESCRIPTION OF THE DRAWINGS

FIG. 1 illustrates a flowchart diagram of an exemplary data analyzing and processing flow consistent with certain disclosed embodiments;

FIG. 2 illustrates a block diagram of a computer system consistent with certain disclosed embodiments;

FIG. 3 illustrates a flowchart of an exemplary zeta optimization process performed by a disclosed computer system; and

FIG. 4 illustrates a flowchart of an exemplary zeta statistic parameter calculation process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

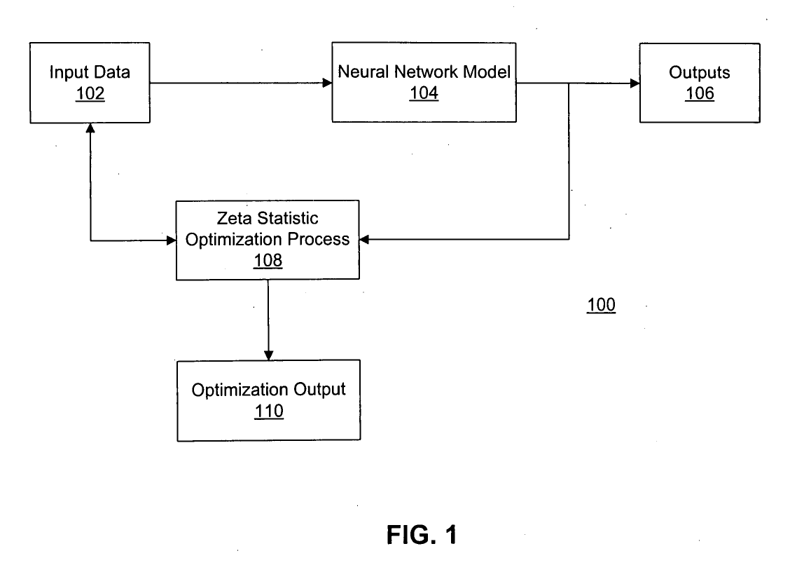

FIG. 1 illustrates a flowchart diagram of an exemplary data analyzing and processing flow 100 using zeta statistic processing and incorporating certain disclosed embodiments. As shown in FIG. 1, input data 102 may be provided to a neural network model 104 to build interrelationships between outputs 106 and input data 102. Input data 102 may include any data records collected for a particular application. Such data records may include manufacturing data, design data, service data, research data, financial data, and/or any other type of data. Input data 102 may also include training data used to build neural network model 104 and testing data used to test neural network model 104. In addition, input data 102 may also include simulation data used to observe and optimize input data selection, neural network model 104, and/or outputs 106.

Neural network model 104 may be any appropriate type of neural network based mathematical model that may be trained to capture interrelationships between input parameters and outputs. Although FIG. 1 shows neural network model 104, other appropriate types of mathematic models may also be used. Once neural network model 104 is trained, neural network model 104 may be used to produce outputs 106 when provided with a set of input parameters (e.g., input data 102). An output of neural network model 104 may have a statistical distribution based on ranges of corresponding input parameters and their respective distributions. Different input parameter values may produce different output values. The ranges of input parameters to produce normal or desired outputs, however, may vary.

A zeta statistic optimization process 108 may be provided to identify desired value ranges (e.g., desired distributions) of input parameters to maximize the probability of obtaining a desired output or outputs. Zeta statistic may refer to a mathematic concept reflecting a relationship between input parameters, their value ranges, and desired outputs. Zeta statistic may be represented as

$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) , \qquad ( 1 )$$

where \overline{x}ᵢ represents the mean or expected value of an ith input; \overline{x}ⱼ represents the mean or expected value of a jth output; σᵢ represents the standard deviation of the ith input; σⱼ represents the standard deviation of the jth output; and |Sᵢⱼ| represents the partial derivative or sensitivity of the jth output to the ith input. Combinations of desired values of input parameters may be determined based on the zeta statistic calculated and optimized. The zeta statistic ζ may also be referred to as a process stability metric, the capability for producing consistent output parameter values from highly variable input parameter values. Results of the zeta optimization process may be outputted to other application software programs or may be displayed (optimization output 110). The optimization processes may be performed by one or more computer systems.

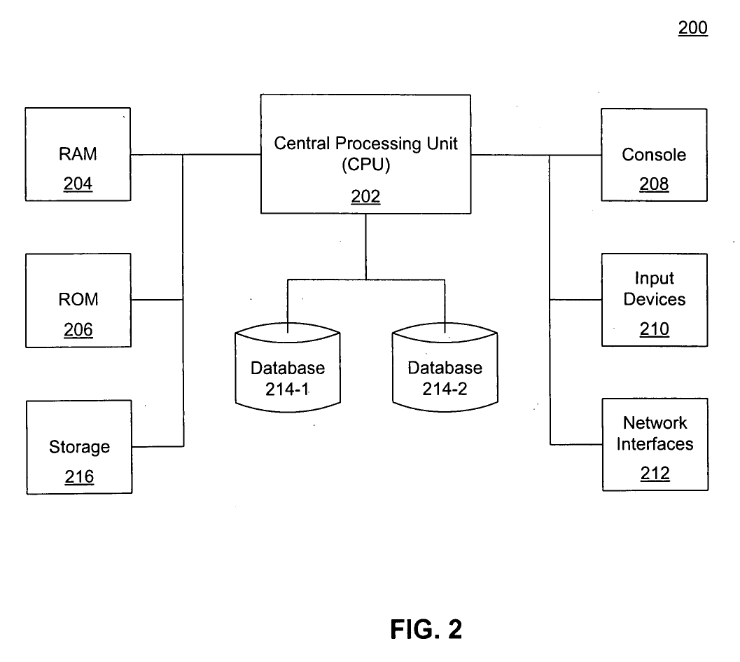

FIG. 2 shows a functional block diagram of an exemplary computer system 200 configured to perform these processes. As shown in FIG. 2, computer system 200 may include a central processing unit (CPU) 202, a random access memory (RAM) 204, a read-only memory (ROM) 206, a console 208, input devices 210, network interfaces 212, databases 214-1 and 214-2, and a storage 216. It is understood that the type and number of listed devices are exemplary only and not intended to be limiting. The number of listed devices may be varied and other devices may be added.

CPU 202 may execute sequences of computer program instructions to perform various processes, as explained above. The computer program instructions may be loaded into RAM 204 for execution by CPU 202 from a read-only memory (ROM). Storage 216 may be any appropriate type of mass storage provided to store any type of information CPU 202 may access to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display devices or computer monitors. Input devices 210 may be provided for users to input information into computer system 200. Input devices 210 may include a keyboard, a mouse, or other optical or wireless computer input devices. Further, network interfaces 212 may provide communication connections such that computer system 200 may be accessed remotely through computer networks.

Databases 214-1 and 214-2 may contain model data and any information related to data records under analysis, such as training and testing data. Databases 214-1 and 214-2 may also include analysis tools for analyzing the information in the databases. CPU 202 may also use databases 214-1 and 214-2 to determine correlation between parameters.

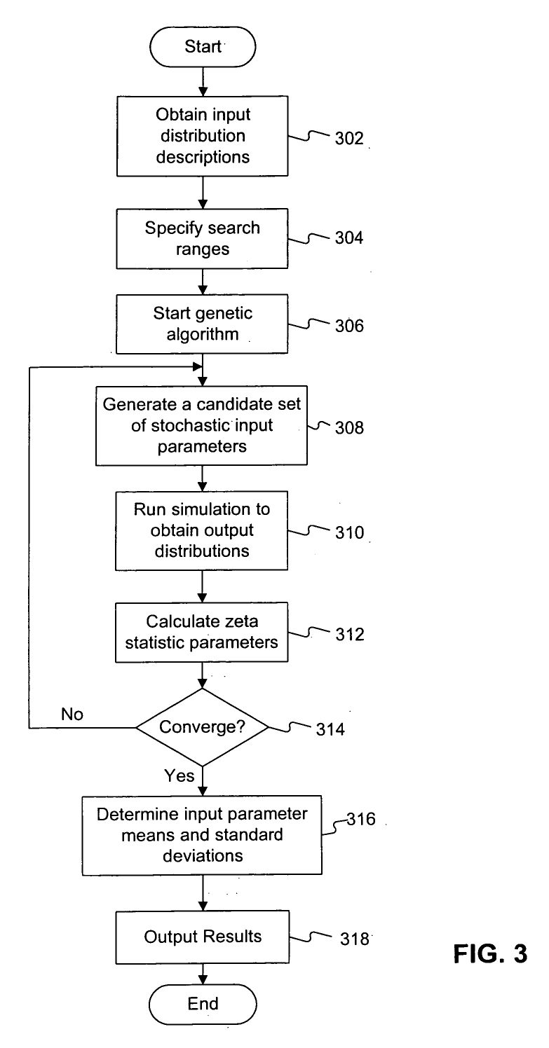

As explained above, computer system 200 may perform process 108 to determine desired distributions (e.g., means, standard deviations, etc.) of input parameters. FIG. 3 shows an exemplary flowchart of a zeta optimization process included in process 108 performed by computer system 200 and, more specifically, by CPU 202 of computer system 200.

As shown in FIG. 3, CPU 202 may obtain input distribution descriptions of stochastic input parameters (step 302). A distribution description of an input parameter may include a normal value for the input parameter and a tolerance range. Within the tolerance range about the normal value, the input parameter may be considered normal. Outside this range, the input parameter may be considered abnormal. Input parameters may include any appropriate type of input parameter corresponding to a particular application, such as a manufacture, service, financial, and/or research project. Normal input parameters may refer to dimensional or functional characteristic data associated with a product manufactured within tolerance, performance, characteristic data of a service process performed within tolerance, and/or other characteristic data of any other products and processes. Normal input parameters may also include characteristic data associated with design processes. Abnormal input parameters may refer to any characteristic data that may represent characteristics of products, processes, etc., made or performed outside of a desired tolerance. It may be desirable to avoid abnormal input parameters.

The normal values and ranges of tolerance may be determined based on deviation from target values, discreteness of events, allowable discrepancies, and/or whether the data is in distribution tails. In certain embodiments, the normal values and ranges of tolerance may also be determined based on experts' opinion or empirical data in a corresponding technical field. Alternatively, the normal value and range of tolerance of an individual input parameter may be determined by outputs 106. For example, an input parameter may be considered as normal if outputs 106 based on the input parameter are in a normal range.

After obtaining input parameter distribution description (step 302), CPU 202 may specify search ranges for the input parameters (step 304). Search ranges may be specified as the normal values and tolerance ranges of individual input parameters. In certain embodiments, search ranges may also include values outside the normal tolerance ranges if there is indication that such out-of-range values may still produce normal outputs when combined with appropriate values of other input parameters.

CPU 202 may setup and start a genetic algorithm as part of the zeta optimization process (step 306). The genetic algorithm may be any appropriate type of genetic algorithm that may be used to find possible optimized solutions based on the principles of adopting evolutionary biology to computer science. When applying a genetic algorithm to search a desired set of input parameters, the input parameters may be represented by a parameter list used to drive an evaluation procedure of the genetic algorithm. The parameter list may be called a chromosome or a genome. Chromosomes or genomes may be implemented as strings of data and/or instructions.

Initially, one or several such parameter lists or chromosomes may be generated to create a population. A population may be a collection of a certain number of chromosomes. The chromosomes in the population may be evaluated based on a fitness function or a goal function, and a value of suitability or fitness may be returned by the fitness function or the goal function. The population may then be sorted, with those having better suitability more highly ranked.

The genetic algorithm may generate a second population from the sorted population by using genetic operators, such as, for example, selection, crossover (or reproduction), and mutation. During selection, chromosomes in the population with fitness values below a predetermined threshold may be deleted. Selection methods, such as roulette wheel selection and/or tournament selection, may also be used. After selection, a reproduction operation may be performed upon the selected chromosomes. Two selected chromosomes may be crossed over along a randomly selected crossover point. Two new child chromosomes may then be created and added to the population. The reproduction operation may be continued until the population size is restored. Once the population size is restored, mutation may be selectively performed on the population. Mutation may be performed on a randomly selected chromosome by, for example, randomly altering bits in the chromosome data structure.

Selection, reproduction, and mutation may result in a second generation population having chromosomes that are different from the initial generation. The average degree of fitness may be increased by this procedure for the second generation, since better fitted chromosomes from the first generation may be selected. This entire process may be repeated for any desired number of generations until the genetic algorithm converges. Convergence may be determined if the rate of improvement between successive iterations of the genetic algorithm falls below a predetermined threshold.

When setting up the genetic algorithm (step 306), CPU 202 may also set a goal function for the genetic algorithm. As explained above, the goal function may be used by the genetic algorithm to evaluate fitness of a particular set of input parameters. For example, the goal function may include maximizing the zeta statistic based on the particular set of input parameters. A larger zeta statistic may allow a larger dispersions for these input parameters, thus, having a higher fitness, while still maintaining normal outputs 106. A goal function to maximize the zeta statistic may cause the genetic algorithm to choose a set of input parameters that have desired dispersions or distributions simultaneously.

After setting up and starting the genetic algorithm, CPU 202 may cause the genetic algorithm to generate a candidate set of input parameters as an initial population of the genetic algorithm (step 308). The candidate set may be generated based on the search ranges determined in step 304. The genetic algorithm may also choose the candidate set based on user inputs. Alternatively, the genetic algorithm may generate the candidate set based on correlations between input parameters. For example, in a particular application, the value of one input parameter may depend on one or more other input parameters (e.g., power consumption may depend on fuel efficiency, etc.). Further, the genetic algorithm may also randomly generate the candidate set of input parameters as the initial population of the genetic algorithm.

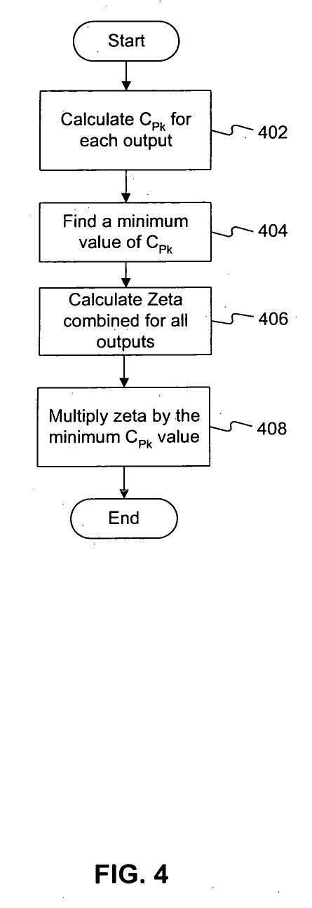

Once the candidate set of stochastic input parameters are generated (step 308), CPU 202 may run a simulation operation to obtain output distributions (step 310). For example, CPU 202 may provide the candidate set of input parameters to neural network model 104, which may generate a corresponding set of outputs 106. CPU 202 may then derive the output distribution based on the set of outputs. Further, CPU 202 may calculate various zeta statistic parameters (step 312). FIG. 4 shows a calculation process for calculating the zeta statistic parameters.

As shown in FIG. 4, CPU 202 may calculate the values of variable Cₚₖ for individual outputs (step 402). The variable Cₚₖ may refer to a compliance probability of an output and may be calculated as

$${C}_{pk} = min \{ \frac{\overline{x} - LCL}{3 σ} , \frac{UCL - \overline{x}}{3 σ} \} , \qquad ( 2 )$$

where LCL is a lower control limit, UCL is a upper control limit, \overline{x} is mean value of output x, and 3σ is a standard deviation of output x. The lower control limit and the upper control limit may be provided to set a normal range for the output x. A smaller Cₚₖ may indicate less compliance of the output, while a larger Cₚₖ may indicate better compliance.

Once the values of variable Cₚₖ for all outputs are calculated, CPU 202 may find a minimum value of Cₚₖ as C_{pk, worst} (step 404). Concurrently, CPU 202 may also calculate zeta value ζ as combined for all outputs (step 406). The zeta value ζ may be calculated according to equation (1). During these calculations, \overline{x}ᵢ and σᵢ may be obtained by analyzing the candidate set of input parameters, and \overline{x}ⱼ and σⱼ may be obtained by analyzing the outputs of the simulation. Further, |Sᵢⱼ| may be extracted from the trained neural network as an indication of the impact of ith input on the jth output. After calculating the zeta value ζ, CPU 202 may further multiply the zeta value ζ by the minimum Cₚₖ value, C_{pk, worst}, (step 408) and continue the genetic algorithm process.

Returning to FIG. 3, CPU 202 may determine whether the genetic algorithm converges on the selected subset of parameters (step 314). As explained above, CPU 202 may set a goal function during initialization of the genetic algorithm to evaluate chromosomes or parameter lists of the genetic algorithm. In certain embodiments, the goal function set by CPU 202 may be to maximize the product of ζ and C_{pk, worst}. If the product of ζ and C_{pk, worst} is above a predetermined threshold, the goal function may be satisfied. The value of calculated product of ζ and C_{pk, worst} may also returned to the genetic algorithm to evaluate an improvement during each generations. For example, the value of product of ζ and C_{pk, worst} may be compared with the value of product of ζ and C_{pk, worst} of previous iteration of the genetic algorithm to decide whether an improvement is made (e.g., a larger value) and to determine an improvement rate. CPU 202 may determine whether the genetic algorithm converges based on the goal function and a predetermined improvement rate threshold. For example, the rate threshold may be set at approximately between 0.1% to 1% depending on types of applications.

If the genetic algorithm does not converge on a particular candidate set of input parameters (step 314; no), the genetic algorithm may proceed to create a next generation of chromosomes, as explained above. The zeta optimization process may go to step 308. The genetic algorithm may create a new candidate set of input parameters for the next iteration of the genetic algorithm (step 308). The genetic algorithm may recalculate the zeta statistic parameters based on the newly created candidate set of input parameters or chromosomes (steps 310 and 312).

On the other hand, if the genetic algorithm converges on a particular candidate set of input parameters (step 314; yes), CPU 202 may determine that an optimized input parameter set has been found. CPU 202 may further determine mean and standard deviations of input parameters based on the optimized input parameter set (316). Further, CPU 202 may output results of the zeta optimization process (step 318). CPU 202 may output the results to other application software programs or, alternatively, display the results as graphs on console 208.

Additionally, CPU 202 may create a database to store information generated during the zeta optimization process. For example, CPU 202 may store impact relationships between input parameters and outputs. If the database indicates that the value of a particular input parameter varies significantly within the search range with little change to the output, CPU 202 may identify the particular input parameter as one having only a minor effect on the output. An impact level may be predetermined by CPU 202 to determine whether the effect is minor (i.e., below the impact level). CPU 202 may also output such information to users or other application software programs. For instance, in a design process, such information may be used to increase design tolerance of a particular design parameter. In a manufacture process, such information may also be used to reduce cost of a particular part.

On the other hand, CPU 202 may also identify input parameters that have significant impact on outputs. CPU 202 may further use such information to guide the zeta optimization process in a particular direction based on the impact probability, such as when a new candidate set of input parameters is generated. For example, the optimization process may focus on the input parameters that have significant impact on outputs. CPU 202 may also provide such information to users or other application software programs.

### INDUSTRIAL APPLICABILITY

The disclosed zeta statistic process methods and systems provide a desired solution for effectively identifying input target settings and allowed dispersions in one optimization routine. The disclosed methods and systems may also be used to efficiently determine areas where input dispersion can be increased without significant computational time. The disclosed methods and systems may also be used to guide outputs of mathematical or physical models to stability, where outputs are relatively insensitive to variations in the input domain. Performance of other statistical or artificial intelligence modeling tools may be significantly improved when incorporating the disclosed methods and systems.

Certain advantages may be illustrated by, for example, designing and manufacturing an engine component using the disclosed methods and systems. The engine components may be assembled by three parts. Under conventional practice, all three parts may be designed and manufactured with certain precision requirements (e.g., a tolerance range). If the final engine component assembled does not meet quality requirements, often the precision requirements for all three parts may be increased until these parts can produce a good quality component. On the other hand, the disclosed methods and systems may be able to simultaneously find desired distributions or tolerance ranges of the three parts to save time and cost. The disclosed methods and systems may also find, for example, one of the three parts that has only minor effect on the component quality. The precision requirement for the one with minor effect may be lowered to further save manufacturing cost.

The disclosed zeta statistic process methods and systems may also provide a more effective solution to process modeling containing competitive optimization requirements. Competitive optimization may involve finding the desired input parameters for each output parameter independently, then performing one final optimization to unify the input process settings while staying as close as possible to the best possible outcome found previously. The disclosed zeta statistic process methods and systems may overcome two potential risks of the competitive optimization (e.g., relying on sub-optimization to create a reference for future optimizations, difficult or impractical trade off between two equally balanced courses of action, and unstable target values with respect to input process variation) by simultaneously optimizing a probabilistic model of competing requirements on input parameters. Further, the disclosed methods and systems may simultaneously find desired distributions of input parameters without prior domain knowledge and may also find effects of variations between input parameters and output parameters.

Other embodiments, features, aspects, and principles of the disclosed exemplary systems will be apparent to those skilled in the art and may be implemented in various environments and systems.

What is claimed is:

1. A computer-implemented method for model optimization, comprising:
obtaining respective distribution descriptions of a plurality of input parameters to a model;
specifying respective search ranges for the plurality of input parameters;
simulating the model to determine a desired set of input parameters based on a zeta statistic of the model; and
determining respective desired distributions of the input parameters based on the desired set of input parameters.

2. The computer-implemented method according to claim 1, wherein the zeta statistic ζ is represented by:
$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input.

3. The computer-implemented method according to claim 1, further including:
displaying graphs of the desired distributions of the input parameters.

4. The computer-implemented method according to claim 1, further including:
outputting the desired distributions of the input parameters.

5. The computer-implemented method according to claim 1, wherein simulating includes:
starting a genetic algorithm;
generating a candidate set of input parameters;
providing the candidate set of input parameters to the model to generate one or more outputs;
obtaining output distributions based on the one or more outputs;
calculating respective compliance probabilities of the one or more outputs; and
calculating a zeta statistic of the model.

6. The computer-implemented method according to claim 5, further including:
determining a minimum compliant probability from the respective compliant probabilities of the one or more outputs.

7. The computer-implemented method according to claim 6, further including:
setting a goal function of the genetic algorithm to maximize a product of the zeta statistic and the minimum compliant probability, the goal function being set prior to starting the genetic algorithm.

8. The computer-implemented method according to claim 7, wherein the simulating further includes:
determining whether the genetic algorithm converges; and
identifying the candidate set of input parameters as the desired set of input parameters if the genetic algorithm converges.

9. The computer-implemented method according to claim 8, further including:
choosing a different candidate set of input parameters if the genetic algorithm does not converge; and
repeating the step of simulating to identify a desired set of input parameters based on the different candidate set of input parameters.

10. The computer-implemented method according to claim 8, further including:
identifying one or more input parameters having a impact on the outputs that is below a predetermined level.

11. A computer system, comprising:
a console;
at least one input device; and
a central processing unit (CPU) configured to:
obtain respective distribution descriptions of a plurality of input parameters to a model;
specify respective search ranges for the plurality of input parameters;
simulate the model to determine a desired set of input parameters based on a zeta statistic of the model; and
determine respective desired distributions of the input parameters based on the desired set of input parameters.

12. The computer system according to claim 11, wherein the CPU is configured to calculate zeta statistic ζ:
$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input.

13. The computer system according to claim 11, the CPU being further configured to:
display graphs of the desired distributions of the input parameters.

14. The computer system according to claim 11, wherein, to simulate the model, the CPU is configured to:
set a goal function of a genetic algorithm to maximize a product of the zeta statistic and a minimum compliant probability;
start the genetic algorithm;
generate a candidate set of input parameters;
provide the candidate set of input parameters to the model to generate one or more outputs; and
obtain output distributions based on the one or more outputs;

15. The computer system according to claim 14, the CPU being further configured to:
calculate respective compliance probabilities of the one or more outputs;
determine the minimum compliant probability from the respective compliance probabilities of the one or more outputs;
calculate the zeta statistic of the model; and
calculate a product of the zeta statistic and the minimum compliant probability.

16. The computer system according to claim 15, the CPU being further configured to:
determine whether the genetic algorithm converges; and
identify the candidate set of input parameters as the desired set of input parameters if the genetic algorithm converges.

17. The computer system according to claim 16, the CPU being further configured to:
choose a different candidate set of input parameters if the genetic algorithm does not converge; and
repeat the step of simulating to identify a desired set of input parameters based on the different candidate set of input parameters.

18. The computer system according to claim 16, the CPU being further configured to:
identify one or more input parameters not having significant impact on the outputs.

19. The computer system according to claim 11, further including:
one or more databases; and
one or more network interfaces.

20. A computer-readable medium for use on a computer system configured to perform a model optimization procedure, the computer-readable medium having computer-executable instructions for performing a method comprising:
obtaining distribution descriptions of a plurality of input parameters to a model;
specifying respective search ranges for the plurality of input parameters;
simulating the model to determine a desired set of input parameters based on a zeta statistic of the model; and
determining desired distributions of the input parameters based on the desired set of input parameters.

21. The computer-readable medium according to claim 20, wherein simulating includes:
setting a goal function of a genetic algorithm to maximize a product of the zeta statistic and a minimum compliant probability;
starting the genetic algorithm;
generating a candidate set of input parameters;
providing the candidate set of input parameters to the model to generate one or more outputs; and
obtaining output distributions based on the one or more outputs;

22. The computer-readable medium according to claim 21, wherein simulating further includes:
calculating respective compliant probabilities of the one or more outputs;
determining the minimum compliant probability from the respective compliance probabilities of the one or more outputs;
calculating the zeta statistic of the model; and
calculating the product of the zeta statistic and the minimum compliant probability.

23. The computer-readable medium according to claim 22, wherein simulating further includes:
determining whether the genetic algorithm converges; and
identifying the candidate set of input parameters as the desired set of input parameters if the genetic algorithm converges.

24. The computer-readable medium according to claim 23, wherein simulating further includes:
choosing a different candidate set of input parameters if the genetic algorithm does not converge; and
repeating the step of simulating to identify a desired set of input parameters based on the different candidate set of input parameters.

25. The computer-readable medium according to claim 23, wherein simulating further includes:
identifying one or more input parameters not having significant impact on the outputs.
